(19) United States
(12) Patent Application Publication
(10) Pub. No.: US 2008/0032094 A1
(43) Pub. Date: Feb. 7, 2008

(54) Moldable composite sheet with improved adhesion at elevated service temperatures

(76) Inventors: Venkat Raghavendran, Forest, VA (US); Daniel Scott Woodman, Lynchburg, VA (US); Jesse Guy Hipwell, Grand Blanc, MI (US)

Correspondence Address: MARK L. WARZEL, 10252 OVERHILL DRIVE, SANTA ANA, CA, 92705, US

(21) Appl. No.: 11/799,450

(22) Filed: Apr. 30, 2007

Related U.S. Application Data
(60) Provisional application No. 60/795,852, filed on Apr. 28, 2006.

(51) Int. Cl. B32B 7/12; B32B 3/10

(52) U.S. Cl. 428/138; 428/317.1; 428/344; 428/353

(57) ABSTRACT

A moldable composite sheet having improved adhesion characteristics, particularly at elevated service temperatures, as well as improved sound absorption and attenuation of transmitted sound intensities. In one aspect, the composite sheet may be a porous fiber-reinforced thermoplastic comprising discontinuous reinforcing fibers and having an adhesive skin layer covering. Generally, the-composite sheet may have a void content or porosity from about 5% to about 95% by volume of the sheet, an areal weight between about 400 g/m² to about 4000 g/m² and a fiber content from about 20% to about 98% by weight. The composite sheet can be molded via low pressure processes, such as thermoforming, match metal molding on stops, vacuum forming and pressure forming, to produce durable automotive interior trim parts capable of withstanding service temperatures exceeding 100° C. for extended periods of time along with improved sound absorption capabilities exceeding a noise reduction coefficient (NRC) rating of 0.5.

### CROSS REFERENCE TO RELATED APPLICATIONS

This application claims priority under 35 U.S.C. §119(e)(1) to U.S. Provisional Application No. 60/795,852, filed Apr. 28, 2006, which is hereby incorporated by reference in its entirety.

### FIELD OF THE INVENTION

This invention relates generally to moldable composite sheet materials, the use of such materials to form moldable articles, and to improvements in the adhesive characteristics of such materials and articles formed therefrom. Specifically, the invention relates to fiber-reinforced composite sheet materials having improved thermal adhesive characteristics wherein the composite sheet material exhibits improved adhesion to a cover material adhered to an adhesive skin layer. Although not limited thereto, the invention is useful in the manufacture of automotive articles, such as a parcel shelf, package tray, headliner, door module, instrument panel topper, front and/or rear pillar trim, or a sunshade, in which the improved thermal adhesive characteristics provide advantages over other materials utilized for such applications.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive industry where developers and manufacturers of articles for automotive applications must meet a number of competing performance specifications for such articles.

For example, automotive interior trims exposed to direct sunlight, such as instrument panels, front and rear pillar trims, parcel shelves or package trays under or around the front and the back windshield, tend to experience extremely high surface heating when such vehicles are parked in non-shaded areas and during the summer months in many parts of the world. The exposed surfaces of the automotive interior trims are known to reach temperatures in excess of 100° C., especially in tropical and equatorial regions of the world. Many automobile OEMs have specified stringent performance requirements to address the durability of automotive interior trims exposed to such high service temperatures. For example, General Motor's subsidiary Holden Limited in its specification No. HN 1311 (Holden Limited publication: “Durability Requirements for Interior Parts,” released October 1972 and revised February 2004) requires all type 4 classified parts (HN 1311, Section 3, Clause 3.4) meeting the guidelines for direct exposure to sunlight to withstand environmental heat aging at 125+/−2° C. for four hours followed by exposure at 110+/−2° C. for seven days (HN 1311, Section 4, Clause 4.3, sub-clause 4.3.1d) without any visually apparent surface changes in the decorative appearance or surface delamination while maintaining a peel adhesion strength of at least 525 N/m (HN1311, Section 4, Clause 4.8).

In an effort to address these demands, a number of composite materials have been developed, including glass mat thermoplastic (GMT) composites. GMT composites provide a number of advantages, e.g., they can be molded and formed into a variety of suitable products both structural and non-structural, including, among many others, automotive bumpers, interior headliners, and interior and exterior trim parts. The traditional GMT used in exterior structural application are generally compression flow molded and are substantially void free in their final part shape. The low density GMT (LD-GMT)used in the interior trim applications are generally semi-structural in nature and are porous and light weight with densities ranging from 0.1 to 1.8 g/cm³ and containing 5% to 95% voids distributed uniformly through the thickness of the finished part. The stringent environmental exposure requirements for certain automotive interior applications, as noted above, have been difficult to meet, however, for existing LD-GMT products, particularly in the area of heat aging resistance (e.g., peel adhesion strength retention and surface delamination resistance). As a result, a continuing need exists to provide further improvements in the ability of composite sheet materials such as LD-GMT composites to meet such performance standards.

### SUMMARY OF THE INVENTION

The present invention is addressed to the aforementioned need in the art, and provides a novel composite sheet material having improved thermal adhesive characteristics. For example, in one aspect, the composite sheet material exhibits improved adhesion to a cover material adhered to an adhesive skin layer. Articles formed from the composite sheet material of the invention may also exhibit improved thermal stability characteristics thereby allowing for the manufacture of new articles requiring such characteristics, particularly in automotive interior applications.

Generally, the moldable composite sheet material comprises a thermoplastic resin, discontinuous fibers dispersed within the thermoplastic resin, and an adhesive skin layer on the surface of the fiber-containing thermoplastic resin. In one aspect, the moldable composite sheet material exhibits improved adhesion to a cover material adhered to the adhesive skin layer relative to a comparative composite sheet material differing from the moldable composite sheet material only in that the adhesive skin layer of the comparative composite sheet material is thinner than the adhesive layer of the moldable composite sheet material. In this regard, the invention is partly attributable to the unexpected discovery that beneficial improvements in adhesion and thermal stability of composite articles may be obtained by utilizing a thicker gage adhesive skin layer in the moldable composite sheet material relative to a comparative composite sheet material having a thinner gage adhesive skin layer.

### BRIEF DESCRIPTION OF THE DRAWINGS

FIG. 1 depicts comparative data obtained for samples 1-14 as described in the Examples.

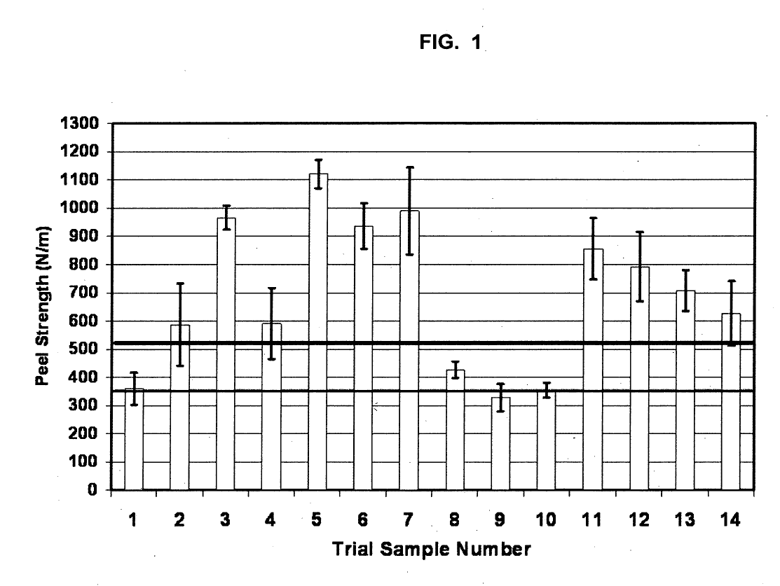

### DETAILED DESCRIPTION OF THE INVENTION

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of a sheet material, and the like.

As used herein, the term “about” is intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified. When used to modify particular numerical values or ranges, the phrases “greater than about” or “less than about” refer to amounts or ranges that are respectively greater than or less than the amounts or ranges encompassed by the term “about”.

In this specification and in the claims that follow, reference is also made to a certain terms, which shall be defined to have the following meanings:

The term “basis weight” generally refers to the areal density of a fiber reinforced thermoplastic material, typically expressed in grams per square meter (g/m² or gsm) of the material in sheet form. The term “reduced basis weight” refers to a reduction in the basis weight that may be realized for materials according to the invention relative to a comparative material. As used herein, the “comparative glass fiber reinforced thermoplastic sheet material” differs from the inventive material at least in one characteristic of the thermoplastic sheet material, such as sheet thickness.

The term “fabric” as used herein denotes a two- or possibly three-dimensional product built up from oriented fibers. These fibers may occur in the fabric uni-directionally (uni-directional thread as warp with an occasional woof thread), bi-directionally with different warp and woof ratios, or tri-directionally. The term “mat” generally refers to random filaments of fibers of relatively short length pressed into a sheet.

As used herein, the phrase “improved adhesion” is intended to include any improvement that is associated with the adhesion of a cover material applied to the composite sheet material of the invention using an adhesive layer applied to one or more surfaces of the composite, the adhesive layer being interposed between the composite sheet material and the cover material. Such improvements include, without limitation, increased adhesive strength of the cover material to the composite sheet material (e.g., as measured by peel adhesion strength), as well as other adhesive characteristics, such as improved delamination resistance, or improved resistance to adhesive failure under various environmental and/or use conditions, and the like. The phrase “cover material” refers to any material, e.g. in sheet or other form, without limitation, that may be applied to the adhesive layer.

The moldable composite sheet material of the invention includes a thermoplastic resin, discontinuous fibers dispersed within the thermoplastic resin, and an adhesive skin layer on the surface of the fiber-containing thermoplastic resin.

The thermoplastic resin may generally be any thermoplastic resin having a melt temperature below the resin degradation temperature. Non-limiting examples of such resins include polyolefins such as polyethylene and polypropylene, thermoplastic polyolefin blends, polyvinyl polymers such as polyvinylalcohol (PVA), polyvinylacetate (PVAc), ethylenevinylacetate copolymer (EVA), polyvinylchloride (PVC), polyvinylidenechloride (PVDC), copolymers of vinylchloride and vinylidenechloride or polyvinylidenefluoride (PVDF or PVF2), diene polymers such as polybutadiene, polyamides such as nylon 6, nylon 6,6, nylon 4,6, nylon 8, nylon 6,10, nylon 11, and nylon 12, polyesters such as polyethyleneterephthalate (PET), and polybutadieneterephthalate (PBT) and polypropyleneterephthalate, polycarbonates, polyestercarbonates, styrene-containing polymers such as polystyrene, acrylonitrylstyrene polymers, acrylonitrile-butylacrylate-styrene polymers, acrylic polymers, including polyacrylates such as polymethyl methacrylate and other acrylic polymers such as ethylene acrylic acid copolymers, polyimides such as polyetherimide (PEI) and polyamideimide (PAI), polyphenylene ether, polyphenylene oxide, polyphenylenesulphide, polyethers, polyetherketones, polyacetals, polyurethanes, polybenzimidazole, and copolymers or mixtures thereof. Other suitable thermoplastic resins will be apparent to the skilled artisan.

Fibers suitable for use in the invention include glass fibers, carbon fibers, synthetic organic fibers, particularly high modulus organic fibers such as para- and meta-aramid fibers, natural fibers such as hemp and sisal, mineral fibers such as basalt, metal and/or metalized or coated fibers including fibers containing or coated with steel, aluminum, copper and/or zinc, or mixtures thereof. Typically, the fiber content is from about 20% to about 98% by weight of the thermoplastic resin. Fibers suitable for use herein are further described in the patent literature (as noted below), and typically have dimensions in the range of about 7 mm to about 50 mm in length with the diameter not less than about 7 microns.

As the thermoplastic resin containing dispersed fibers, the moldable composite sheet of the invention may, according to one embodiment, include a low density glass mat thermoplastic composite (GMT). One such mat is prepared by AZDEL, Inc. and sold under the trademark SUPERLITE® mat. Preferably, the areal density of the such a GMT is from about 400 grams per square meter of the GMT (g/m²) to about 4000 g/m², although the areal density may be less than 400 g/m² or greater than 4000 g/m² depending on the specific application needs. Preferably, the upper density should be less than about 4000 g/m².

The SUPERLITE® mat is prepared using chopped glass fibers, a thermoplastic resin binder and a thermoplastic polymer film or films and or woven or non-woven fabrics made with glass fibers or thermoplastic resin fibers such as polypropylene (PP), polybutylene terephethalate (PBT), polyethylene terephthalate (PET), polycarbonate (PC), a blend of PC/PBT, or a blend of PC/PET. Generally, PP, PBT, PET, and PC/PET and PC/PBT blends are the preferred thermoplastic resins. To produce the low density GMT, the materials and other additives are metered into a dispersing foam contained in an open top mixing tank fitted with an impeller. The foam aides in dispersing the glass fibers and thermoplastic resin binder. The dispersed mixture of glass and thermoplastics binder is pumped to a head-box located above a wire section of a paper machine via a distribution manifold. The foam, not the glass fiber or thermoplastic binder, is then removed as the dispersed mixture passes through a forming support element (e.g., a foraminous element such as a moving wire screen) using a vacuum, continuously producing a uniform, fibrous wet web. The wet web is passed through a dryer to reduce moisture content and to melt the thermoplastic resin binder. When the hot web comes out of the dryer, a multi-layer thermoplastic film is typically laminated into the web by passing the web of glass fiber, thermoplastic binder and thermoplastic polymer film or films through the nip of a set of heated rollers. A non-woven and or woven fabric layer may also be attached along with or in place of the multi-layer thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such GMT composites, including suitable materials used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

Natural (e.g., hemp, sisal) and/or synthetic fibers such as glass fibers, carbon fibers, organic fibers such as para- and meta-polyaramids, polyesters such as polyethylene terephthate fibers, and mineral fibers such as basalt fibers, and metal and/or metalized or coated fibers may also be used for the production (as described above) of such a mat for use in the composite sheet of the invention. Also, various amorphous or crystalline thermoplastic resins as described above may be employed such as polyesters (PET, PBT, PPT), acrylics, HDPE, polyethylene (PET), polypropylene (PP), polycarbonate (PC) or blends of PC/PBT or PC/PET and the like thermoplastic polymers without modification of the web forming process. The ratio of fibers to polymers, as well as the basic weight of the web, can be easily varied in order to meet the particular requirements of cost and material performance of a specific application.

The mat, preferably a low density glass mat (GMT) composite, may be desirably formed into an article by a forming technique such as compression molding or thermoforming, using air or gas pressure as an assist, if desired. Such methods are well-known and described in the literature, e.g., see U.S. Pat. Nos. 6,923,494 and 5,601,679. Thermoforming methods and tools are also described in detail in DuBois and Pribble's “Plastics Mold Engineering Handbook,” Fifth Edition, 1995, pages 468 to 498.

The adhesive skin layer of the moldable composite sheet material may generally be a thermoplastic material applied to the surface of the fiber-containing thermoplastic resin. The skin layer provides at least partial coverage of the surface and may be applied to one or more surfaces. Suitable skin layer thermoplastic materials include any of the thermoplastic resins described hereinabove. In more particular embodiments, the adhesive skin layer is selected from a polyolefin, polyamide, polyester, polyurethane, or mixtures and combinations thereof. The skin layer may be, without limitation, a film, non-woven scrim, veil, woven fabric or a combination thereof. The skin layer is desirably air permeable and can substantially stretch and spread with the fiber-containing composite sheet during thermoforming and/or molding operations. In one further aspect of the invention, the skin layer may be a film that contains perforations and possesses adhesive characteristics so that it provides good adhesion to a cover sheet material applied to the skin layer. The perforated adhesive film also provides enhanced acoustical performance by absorbing, attenuating and reducing the amount of sound intensity transmitted across an article prepared from the moldable composite sheet material. The improved sound absorption capabilities desirably exceed an NRC rating (noise reduction coefficient) of 0.5. In another aspect of the invention, one of the skin layers may be a film that contains a higher temperature barrier layer capable of maintaining the air barrier performance to restrict the flow of air through the composite sheet to improve sound transmission loss performance. The moldable composite sheet material is useful in a variety of applications in which stringent performance characteristics must be met. For example, as noted, in the automotive applications described herein, it is desirable that the durability requirements specified by Holden Limited be achieved for automotive interior parts. Of particular interest, is the ability of the inventive moldable composite sheet material to meet the requirement that the adhesion of a surface cover material to the composite sheet of the invention be greater than a minimum peel strength of 525 N/m and not exhibit substrate delamination following exposure to 23±2° C. and 55±5% RH for 24 hours and 125° C.±2° C. for 4 hours followed by 110° C.±2° C. for 7 days (HN 1311 substrate adhesion durability requirement, section 4, clauses 4.3 and 4.8 for type 4 classified parts). In one very useful embodiment of the invention, as demonstrated in the Examples that follow, the adhesive skin layer comprises a polypropylene resin such that the composite sheet material meets the above-noted HN 1311 substrate adhesion durability requirements when a polyurethane foam is applied as a cover sheet material. It should be noted that such results may be obtained without the use of an adhesion promoter in the adhesive skin layer.

In still further aspects of the invention, the moldable composite sheet material provides improved adhesion to a cover sheet material relative to a comparative composite sheet material when the thickness of the adhesive skin layer is at least about 20%, preferably at least about 35%, and more preferably at least about 45%, greater than the thickness of the adhesive skin layer of the comparative composite sheet material, wherein the moldable composite sheet material and the comparative composite sheet material differ only in the thickness of the respective adhesive skin layers.

Although not limited thereto, the invention is useful in the manufacture of automotive articles, such as a parcel shelf, package tray, headliner, door module, instrument panel topper, front and/or rear pillar trim, or a sunshade, in which the improved thermal adhesive characteristics provide advantages over other materials utilized for such applications.

It is to be understood that while the invention has been described in conjunction with the preferred specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

### EXPERIMENTAL

Porous composite sheet manufactured using the papermaking process (as described and referenced herein) and containing finely dispersed filamentized chopped glass fibers with a nominal diameter of 16 microns and average chopped length of 12.7 mm and 45% by weight polypropylene resin uniformly distributed through the thickness of the sheet and weighing nominally 1000 g/m² was laminated, using a pair of nip rollers, with a light weight polyester spunbond non-woven fabric nominally weighing 20 g/m² on one surface and laminated on the other surface with a polypropylene resin based film nominally weighing 100 g/m² and measuring 110 micron in thickness for Sample A and for sample B a thicker gage film made with the same polypropylene resin as Sample A and weighing on an average 142 g/m² and measuring 160 micron in thickness. Both the films were sourced with the surface perforated. Film surface perforations measured 1.2 mm in diameter and the perforation pattern was 45 holes/10 cm².

The porous composite sheets Sample A & Sample B were then clamped on their longer sides in a clamp frame with the surface containing the polypropylene film facing upwards and subjected to heating in an infrared oven for different amounts of time ranging from 56 seconds to 70 seconds. The rate of heating was regulated to achieve a surface temperature of 200° C. on the polypropylene surface. The polypropylene surface covering is at this stage substantially melted, but still on the surface of the porous composite sheet. The heated sheets were then conveyed to a molding station and molded on stops in a contoured matched metal tool with a 3.5 mm thick polyurethane foam backed woven fabric decorative cover material. The time taken to convey the sheet from the oven to the molding station and closing of the tool was maintained constant for all the different conditions the samples were subjected to. Further, the samples were molded to different thickness by increasing the gap between the mold surfaces using strips of aluminum tapes stacked to achieve an additional 0.00 mm to 0.375 mm thickness. Additionally, the building air conditioner was turned on or off at different times and the roller door at the back of the building was opened or closed to vary the environmental conditions the heated sheet would experience prior to molding. However, since only qualitative information was provided for such variations in ambient conditions, the results observed were considered to be inconclusive and are not presented herein.

The parts molded at different conditions were then sectioned and specimens for peel adhesion tests were collected from the same section of the molded parts and tested for adhesion between the polyurethane foam and the porous composite containing the porous polypropylene covering. The specimens for peel adhesion tests measured 250 mm in length, 25 mm in width. The samples were tested on a calibrated MTS universal tester with a cross-head capable of traversing up and down at constant speeds. The polyurethane foam backed decorative covering was carefully peeled from one side, with the peel progressing parallel to the longitudinal axis for a length of about 150 mm to allow the specimen to be mounted in the tensile tester's grips in a fashion that allows the specimen to experience an 180 degrees angle between the surfaces being peeled apart. Five specimens were tested for each molding condition by subjecting them to a peel test at a constant speed of 300 mm/min. The force required to separate the surfaces and the distance the decorative material was peeled off from the substrate was noted and the average peel adhesion strength of the foam to the polypropylene layer calculated by integrating the area under the peel load vs. peel distance curve and noted with Newton/meter as the units for measurement.

### REFERENCE EXAMPLES 1 & 2

### Peel Adhesion Strength for 110 μm PP Adhesive Films

Composite sheet Samples 1 and 2 having 110 μm adhesive PP films were prepared, from Sample A (described above) and tested for peel adhesion strength to the 3.5 mm thick polyurethane foam backed woven fabric decorative cover material. Sample 1 was heated for 56 sec. and Sample 2 was heated for 70 sec. as described above. Sample 1 exhibited an average peel adhesion strength of 359.5 N/m and Sample 2 exhibited an average peel adhesion strength of 587.2 N/m. Testing conditions and results for Samples 1 and 2 are summarized in Table 1.

### EXAMPLES 1 & 2

### Peel Adhesion Strength for 160 μm PP Adhesive Films

Composite sheet Samples 3 and 4 having 160 μm adhesive PP films were prepared from Sample B (described above) and tested for peel adhesion strength to the 3.5 mm thick polyurethane foam backed woven fabric decorative cover material. Sample 3 was heated for 70 sec. and Sample 4 was heated for 56 sec. as described above. Sample 3 exhibited an average peel adhesion strength of 965.6 N/m and Sample 4 exhibited an average peel adhesion strength of 590.8 N/m. Testing conditions and results for Samples 3 and 4 are summarized in Table 1.

Comparison of Samples 4 and 3 with Samples 1 and 2, respectively, shows that use of the 160 μm adhesive film results in an increase in peel adhesion strength of greater than 60% compared with composite sheet samples having the 110 μm adhesive film.

### EXAMPLES 3-12

### Processing Effects on Peel Adhesion Strength for 160 μm PP Adhesive Films

Composite sheet Samples 5-14 having 160 μm adhesive PP films were prepared from Sample B (described above) and tested for peel adhesion strength to the 3.5 mm thick polyurethane foam backed woven fabric decorative cover material according to the conditions summarized in Table 1 for various heating times and tape thickness values. Peel adhesion strength results for these samples are also presented in Table 1.

TABLE 1
Peel Adhesion Results for Reference Examples 1-2 and Examples 1-12

| | | Peel Adhesion | | Adhesive film | | | | | | | | | | |
|---|---|---|---|---|---|---|---|---|---|---|---|---|---|---|
| | Trial | Strength | | used | | | | | | | | | | |
| Sample | Sample | Average | Std. Dev. | 110 | 160 | Heating time (sec) | | | | | Tape thickness (mm) | | | |
| Type | Number | (N/m) | (N/m) | GSM | GSM | 56 | 58 | 60 | 65 | 70 | 0 | 0.125 | 0.25 | 0.375 |
| Sample A | Sample 1 | 359.5 | 56.8 | ✓ | | ✓ | | | | | ✓ | | | |
| | Sample 2 | 587.2 | 145.3 | ✓ | | | | | | ✓ | ✓ | | | |
| Sample B | Sample 3 | 965.5 | 42.6 | | ✓ | | | | | ✓ | ✓ | | | |
| | Sample 4 | 590.8 | 126.4 | | ✓ | ✓ | | | | | ✓ | | | |
| | Sample 5 | 1120.9 | 50.3 | | ✓ | | | | ✓ | | | ✓ | | |
| | Sample 6 | 937.1 | 80.8 | | ✓ | | | | ✓ | | | | ✓ | |
| | Sample 7 | 989.8 | 153.9 | | ✓ | | | | ✓ | | | | | ✓ |
| | Sample 8 | 427.6 | 29.1 | | ✓ | ✓ | | | | | | ✓ | | |
| | Sample 9 | 327.9 | 48.0 | | ✓ | ✓ | | | | | | | ✓ | |
| | Sample 10 | 353.9 | 26.0 | | ✓ | ✓ | | | | | | | | ✓ |
| | Sample 11 | 856.1 | 108.9 | | ✓ | | | | ✓ | | ✓ | | | |
| | Sample 12 | 792.4 | 122.5 | | ✓ | | | ✓ | | | ✓ | | | |
| | Sample 13 | 708.3 | 72.0 | | ✓ | | ✓ | | | | ✓ | | | |
| | Sample 14 | 626.4 | 114.1 | | ✓ | ✓ | | | | | ✓ | | | |

What is claimed is:

1. A moldable composite sheet material comprising
a thermoplastic resin;
discontinuous fibers dispersed within the thermoplastic resin; and
an adhesive skin layer on the surface of the fiber-containing thermoplastic resin,
wherein the composite sheet material exhibits improved adhesion to a cover material adhered to the adhesive skin layer compared to a comparative composite sheet material differing from the moldable composite sheet material only in that the adhesive skin layer of the comparative composite sheet material is thinner than the adhesive layer of the moldable composite sheet material.

2. The moldable composite sheet material of claim 1, wherein the thickness of the adhesive skin layer is at least about 20% greater than the thickness of the adhesive skin layer of the comparative composite sheet material.

3. The moldable composite sheet material of claim 1, wherein the thickness of the adhesive skin layer is at least about 35% greater than the thickness of the adhesive skin layer of the comparative composite sheet material.

4. The moldable composite sheet material of claim 1, wherein the thickness of the adhesive skin layer is at least about 45% greater than the thickness of the adhesive skin layer of the comparative composite sheet material.

5. The moldable composite sheet material of claim 1, wherein the composite sheet material has a porosity between about 0% to about 95% by volume and an areal density of from about 400 g/m² to about 4000 g/m².

6. The moldable composite sheet material of claim 1, wherein the improved adhesion of the adhesive skin layer of the moldable composite sheet material is obtained without the use of an adhesion modifier.

7. The moldable composite sheet material of claim 1, wherein the adhesive skin layer has a minimum peel adhesion strength to a cover material of 525 N/m.

8. The moldable composite sheet material of claim 7, wherein the moldable composite sheet material does not exhibit substrate delamination following exposure to 23° C.±2° C. and 55±5% RH for 24 hours and 125° C.±2° C. for 4 hours followed by 110° C.±2° C. for 7 days.

9. The moldable composite sheet material of claim 1, wherein the thermoplastic resin is selected from polyolefins, thermoplastic polyolefin blends, polyvinyl polymers, diene polymers, polyamides, polyesters, polycarbonates, polyestercarbonates, styrene-containing polymers, acrylic polymers, polyimides, polyphenylene ether, polyphenylene oxide, polyphenylenesulphide, polyethers, polyetherketones, polyacetals, polyurethanes, polybenzimidazole, and copolymers or mixtures thereof.

10. The moldable composite sheet material of claim 1, wherein the fibers are selected from glass fibers, carbon fibers, synthetic organic fibers, natural fibers, mineral fibers, metal and/or metalized or coated fibers, or mixtures thereof.

11. The moldable composite sheet material of claim 10, wherein the fibers are selected from glass fibers, carbon fibers, polyaramid fibers, polyester fibers, nylon fibers, hemp fibers, sisal fibers, basalt fibers, steel fibers, aluminum fibers, copper fibers, zinc fibers, or mixtures thereof.

12. The moldable composite sheet material of claim 1, wherein the fiber content is from about 20% to about 98% by weight of the thermoplastic resin.

13. The moldable composite sheet material of claim 1, wherein the adhesive skin layer is selected from films, non-woven scrims, veils, woven fabrics, or combinations thereof.

14. The moldable composite sheet material of claim 1, wherein the adhesive skin layer contains perforations.

15. The moldable composite sheet material of claim 14, wherein the adhesive skin layer is selected from a polyolefin, polyamide, polyester, polyurethane, or mixtures and combinations thereof.

16. An article formed from the moldable composite sheet material of claim 1, in the form of an automobile article selected from a parcel shelf, package tray, headliner, door module, instrument panel topper, front and/or rear pillar trim, or a sunshade.

17. In a composite sheet material comprising a thermoplastic resin having discontinuous fibers dispersed therein and an adhesive skin layer on one or more surfaces of the thermoplastic resin, the improvement comprising providing improved adhesion of the adhesive skin layer to a cover material adhered to the adhesive skin layer by utilizing a thicker gage adhesive skin layer in the composite sheet material compared to a comparative composite sheet material differing from the composite sheet material only in that the adhesive skin layer of the comparative composite sheet material has a thinner gage than the adhesive skin layer of the composite sheet material.

18. The moldable composite sheet material of claim 17, wherein the thickness of the adhesive skin layer is at least about 20% greater than the thickness of the adhesive skin layer of the comparative composite sheet material.

19. The moldable composite sheet material of claim 17, wherein the composite sheet material has a porosity between about 0% to about 95% by volume and density of from about 400 g/m² to about 4000 g/m².

20. The moldable composite sheet material of claim 17, wherein the improved adhesion of the adhesive skin layer of the moldable composite sheet material is obtained without the use of an adhesion modifier.

21. The moldable composite sheet material of claim 17, wherein the adhesive skin layer has a minimum peel adhesion strength to a cover material of 525 N/m.

22. The moldable composite sheet material of claim 21, wherein the moldable composite sheet material does not exhibit substrate delamination following exposure to 23° C.±2° C. and 55±5% RH for 24 hours and 125° C.±2° C. for 4 hours followed by 110° C.±2° C. for 7 days.

23. The moldable composite sheet material of claim 17, wherein the thermoplastic resin is selected from polyolefins, thermoplastic polyolefin blends, polyvinyl polymers, diene polymers, polyamides, polyesters, polycarbonates, polyestercarbonates, styrene-containing polymers, acrylic polymers, polyimides, polyphenylene ether, polyphenylene oxide, polyphenylenesulphide, polyethers, polyetherketones, polyacetals, polyurethanes, polybenzimidazole, and copolymers or mixtures thereof.

24. The moldable composite sheet material of claim 17, wherein the fibers are selected from glass fibers, carbon fibers, synthetic organic fibers, natural fibers, mineral fibers, metal and/or metalized or coated fibers, or mixtures thereof.

25. The moldable composite sheet material of claim 24, wherein the fibers are selected from glass fibers, carbon fibers, polyaramid fibers, polyester fibers, nylon fibers, hemp fibers, sisal fibers, basalt fibers, steel fibers, aluminum fibers, copper fibers, zinc fibers, or mixtures thereof.

26. The moldable composite sheet material of claim 17, wherein the fiber content is from about 20% to about 98% by weight of the thermoplastic resin.

27. The moldable composite sheet material of claim 17, wherein the adhesive skin layer is selected from films, non-woven scrims, veils, woven fabrics, or combinations thereof.

28. The moldable composite sheet material of claim 17, wherein the adhesive skin layer contains perforations.

29. The moldable composite sheet material of claim 17, wherein the adhesive skin layer is selected from a polyolefin, polyamide, polyester, polyurethane, or mixtures and combinations thereof.
